(19) United States
(12) Patent Application Publication
(10) Pub. No.: US 2005/0114404 A1
(43) Pub. Date: May 26, 2005

(54) Database table version upload

(75) Inventors: Kevin M. Pintar, Round Rock, TX (US); Kenneth Ziervogel, Cedar Park, TX (US); James W. Magill, Cedar Creek, TX (US)

Correspondence Address: WONG, CABELLO, LUTSCH, RUTHERFORD & BRUCCULERI,;P.C., 20333 SH 249, SUITE 600, HOUSTON, TX, 77070, US

(73) Assignee: BMC Software, Inc., Houston, TX (US)

(21) Appl. No.: 10/718,863

(22) Filed: Nov. 21, 2003

(51) Int. Cl. G06F 12/00

(52) U.S. Cl. 707/200

(57) ABSTRACT

Techniques to extract, or unload, data from a database table based on a specific version of the table are described. Modern database management systems permit a user to change a databases' table structure or schema in response to changing operating conditions without blocking users' access to the underlying table or its data. Once modified, these database management systems permit data retrieval only in terms of a table's most recent version. Applications written to process a table's data in a first version may not be able to process data when that data is conformed to a later version. By providing a means to extract data from a table based on prior versions of that table, the invention permits users to evolve their database structure as needs require, while maintaining the ability to unload data for historical applications.

### BACKGROUND

The invention relates generally to relational database systems and, more particularly but not by way of limitation, to a means for extracting or unloading information from a specified version of a database table.

A database is, fundamentally, a computerized record-keeping system in which large amounts of information may be stored in a structured manner for ease of subsequent retrieval and processing. Large databases are generally managed through data base management systems (DBMS's). A DBMS provides an operational environment through which a user may retrieve or update previously stored information. In one type of DBMS, referred to as a relational database system, information is stored in tables, with each table having one or more columns and one or more rows. Each column in a table is referred to as an attribute of the table. Each row in a table is referred to as a record. Thus, a table typically comprises a plurality of records (rows), each of which has a plurality of attributes (columns). By way of example, a business might maintain a database of employee information. In this example, each record may be associated with an employee, with attributes of each record identifying information such as the employee's name, social security number, address, employee number, department, position, salary, hire date and any other information the business deems useful.

The overall organization or structure of a table is referred to as its “schema.” A schema defines the type and order of a table's attributes (columns), but does not speak to the data that may actually be stored in the table. In the past, when a user (typically a database administrator or “DBA”) wanted to revise a table's schema by changing the characteristic'of a previously defined attribute (e.g., changing a column defined in terms of an integer to one defined as a floating point number and adding a column to a table), the table had to be completely reformulated. In practice this meant: (1) blocking users from accessing the original table; (2) defining a new table schema incorporating the desired change; (3) unloading data from the original table; (4) reloading the data into the newly defined table; (5) substituting the new table for the original table in the database or DMBS; and (6) allowing access to the newly defined and loaded table. For organizations that need 24×7 access to their data, this operation can impose an unacceptable outage to data, especially when the table being reformulated is large.

To overcome this drawback, some modern relational database systems permit users to specify schema changes to a table without causing a user access outage. For example, DB2® from the International Business Machines Corporation of Armonk, N.Y., permits users to make some schema changes without blocking access to the affected table. Over time, a table's schema may be changed repeatedly—each such change giving rise to a “version” of the table. While these systems permit a user to version a table on the fly, any query directed to such a modified table returns results based on the most recent version—reflecting the current state of the table.

This can be a significant problem for large organizations that run applications designed to process data from a prior defined schema. Often times, these applications implement large, complex processing tasks such as payroll processing, customer order processing and inventory control and accounting. The development of these applications are typically time consuming and expensive. Unexpected schema changes can leave such applications non-functional and/or requiring updates on each schema change that affects their processing.

One approach to accommodating a changing schema is to modify the affected applications. This approach can be time consuming, expensive and prone to error—errors that important business processing such as those identified above cannot afford. Another approach is to extract data from the versioned table, convert the data into a format required by the “target” version (i.e., that version the application was designed to operate with), load the converted data into a temporary table and then run the application against this temporary table. This approach can be prohibitively expensive in terms of cost, time to develop and time to execute while also consuming large amounts of storage space (especially if the table being processed is large).

Thus, it would be beneficial to provide a means to query (extract information) from a versioned database table based on a specified version of the table.

### SUMMARY

In one embodiment the invention provides a method to unload or extract a user-specified version of a database object. The method includes receiving a request to extract data from a database table where the database table has a current version associated with a current schema and a prior version associated with a prior schema, the request being directed the prior version, and extracting data from the database table based on the table schema associated with the prior version. In some embodiments, a description of the identified schema may also, or in place of, be output. Methods in accordance with the invention may be stored in any media that is readable and executable by a computer system. Methods in accordance with the invention may also be executed by one or more computer systems.

### BRIEF DESCRIPTION OF THE DRAWINGS

FIG. 1 shows, in flowchart form, a method to extract version-specific information from a database in accordance with one embodiment of the invention.

FIG. 2 shows, in flowchart form, a table extract or unload operation in accordance with one embodiment of the invention.

FIG. 3 shows, in block-diagram form, a response structure in accordance with one embodiment of the invention.

### DETAILED DESCRIPTION

Techniques (including methods and devices) to extract version-specific information from a table having multiple versions are described. The following embodiments of the invention, described in terms of the DB2® database system, are illustrative only and are not to be considered limiting in any respect.

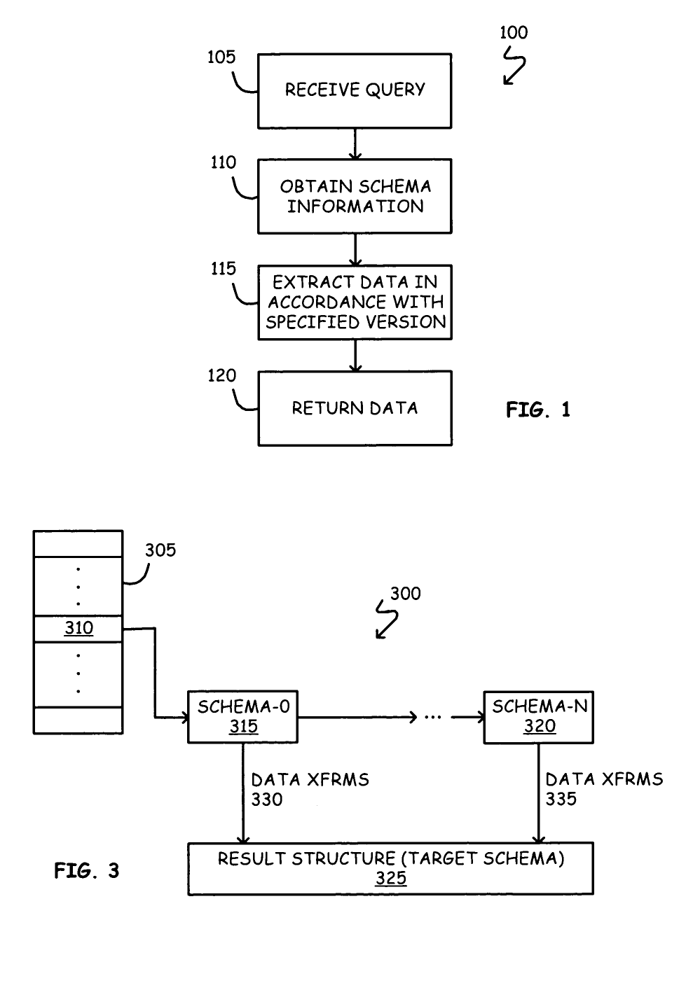

Referring to FIG. 1, in one embodiment of the invention, version-specific unload operation 100 initially receives a query directed to a non-current version of a target table (block 105). That is, if the table being queried is currently defined in terms of version ‘N,’ the query processed in accordance with unload operation 100 is directed to a prior version. Next, information about each schema needed to respond to the query is obtained (block 110). Using the obtained schema information, the query is then processed to extract data (block 115) which is then returned to the requesting entity (block 120).

With respect to the acts of block 105, Table 1 shows an illustrative version-specific query patterned after the Structured Query Language (SQL) SELECT statement. One of ordinary skill in the art will recognize that an SQL query permits a user to select (i.e., extract) one or more columns, zero or more of which may have specified data transformation operations associated therewith [1] from a specified table [2], where the selected data meets zero or more conditional requirements—often referred to as retrieval filters [3]. In addition, and novel to the claimed invention, a query specifies that version of the identified table against which the query is to be executed [4].

TABLE 1
Version-Specific Query (SQL-Like Syntax)

| | |
|---|---|
| SELECT column-name-A . . . function-name(column-name-B) . . . | [1] |
| FROM table-name | [2] |
| WHERE column-name-C <operator-D> <value-E> . . . | [3] |
| VERSION version-identifier | [4] |

As one of ordinary skill in the art will recognize, if no data transformations are specified by the user, the “function-name(column-name-B)” feature of the SELECT statement will not be used. Similarly, if query filtering is not needed, the WHERE clause will not be used.

With respect to the acts of block 110, in one embodiment the user may specify the schema for each version manually—in a format acceptable to the DBMS such as 2 L (Data Description Language) for DB2®. In another embodiment, and for those DBMS systems that maintain versioning information, the DBMS may be queried to obtain this information. In yet another embodiment, a third party database change management utility may be used to obtain this information. One such utility is the CHANGE MANAGER family of products from BMC Software, Inc. of Houston, Tex.

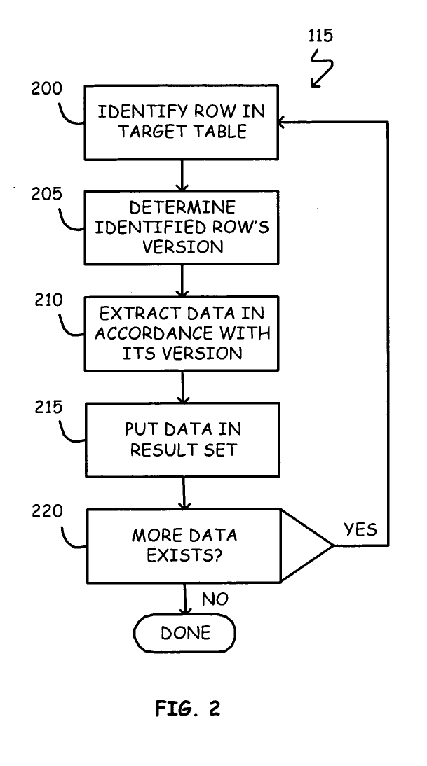

With respect to the acts of block 115, FIG. 2 shows one technique for extracting (also referred to as unloading) data in accordance with the invention. Initially, a first row of the target table is identified (block 200) and it's associated version is identified (block 205). In a database system that permits versioning, each row in a table has an associated identifier that indicates which format (i.e., schema or version) its data conforms to. The user SELECT statement is then applied to the row in accordance with its schema (block 210). When the format of the extracted data (e.g., a single field in the current row) does not match that of the target version, the extracted data may generally be processed in one of three way. First, the extracted data may simply be ignored—not placed into the extracted data set (referred to as the “Result Set”). Second, if the extracted data is capable of being logically converted (e.g., from an integer to a floating point value), the conversion is performed, even if the resulting value is not as “accurate” as the original value. Third, if the data is not capable of being logically converted (e.g., a string value to a decimal type), it may be ignored. When data is not converted or is ignored, this may be represented in the Result Set by an “error” value. Typically, it is during this phase of the extract or unload process that user specified data transformations are also performed (see discussion above regarding Table 1). Once extracted and transformed (if necessary), the data is placed into a Result Set (block 215). If rows remain in the target table that have not been processed in accordance with FIG. 2 (the ‘YES’ prong of block 220), the next row is identified and the acts of blocks 200-215 are repeated. If no rows remain (the ‘NO’ prong of block 220), the acts of block 115 are complete.

With respect to the acts of block 120, in one embodiment, only the extracted (and possibly transformed) data is provided to the requesting entity. This may be the preferred output when the data is being sent directly to a user application. In another embodiment, the designated version's schema definition is output to a separate file. This may be the preferred output when the user wants to instantiate a new table that conforms to the targeted version/schema. In yet another embodiment, both the extracted data and the designated version's schema definition may be output (in one file or in separate files). The ability to specify which of these output types to generate may be provided, for example, through an output-flag attribute of the SELECT statement shown in Table 1.

In an embodiment of the invention designed to unload data from a versioned DB2® table (see FIG. 3), the acts of block 110 are accompanied by the creation of response structure 300. The function of response structure 300 is to permit the automated extraction and conversion (if necessary) of data from the target table, in whatever version it is currently stored, to the target format in accordance with the specified query version (see Table 1 above). Table 305 identifies each table currently known to the DBMS for which data may reside in the tablespace or container being processed (this table may be referred to as the OBID table or index). As shown, table identifier 310 represents the table against which a query has been made. As each schema definition is identified, a schema definition structure is generated that includes the schema's definition (i.e., 315-320). In addition, structure 325 is generated in which to place the data extracted from the target table (identified via 305) via the SELECT statement. Note, structure 325 is that defined by the schema associated with the designated version. In addition, each identified schema structure is associated with structure 325 through transformation routines or utilities (330-335). Once structure 325 is instantiated, the user's SELECT statement is executed against each schema definition (see block 115 of FIG. 1); the extracted data (transformed as necessary by routines 330-330) being placed into structure 325.

As described herein, the invention provides a version-specific means to extract data from a database table. Benefits include, but are not limited, to permitting users to extract data and/or schema descriptions from a table based on a non-current version. Extracted data may be provided to user applications designed to process data from the prior version (schema). In addition, extracted schema information may be used to implement tables based on the prior schema. Other benefits will be recognized by those of ordinary skill in the art of database management and design.

Various changes in the details of the illustrated operational methods are possible without departing from the scope of the claims. For example, while a method has been described in the context of a DB2® database, the invention is equally applicable to other relational database systems. Illustrative relational database systems include Oracle®, Sybase®, Informix®, Microsoft SQL Server and Microsoft Access®. In addition, acts in accordance with FIGS. 1 and 2 may be embodied in one or more computer programs or modules that may be executed by a programmable control device. Storage devices suitable for tangibly embodying computer program instructions include, but not limited to: magnetic disks (fixed, floppy, and removable) and tape; optical media such as CD-ROM disks; and semiconductor memory devices such as Electrically Programmable Read-Only Memory (EPROM), Electrically Erasable Programmable Read-Only Memory (EEPROM), Programmable Gate Arrays and flash devices. Programmable control devices suitable for executing program instructions in accordance with the invention include a single computer processor, a plurality of computer processors coupled by a communications link, or a custom designed state machine.

While the invention has been disclosed with respect to a limited number of embodiments, numerous modifications and variations will be appreciated by those skilled in the art. It is intended, therefore, that the following claims cover all such modifications and variations that may fall within the true spirit and scope of the invention.

1. A database unload method, comprising:
receiving a request to extract data from a database table, the database table having a current version associated with a current schema of the database table and a prior version associated with a prior schema of the database table, the request directed the prior version; and
extracting data from the database table based on the table schema associated with the prior version.

2. The method of claim 1, wherein the act of receiving a request further comprises obtaining schema definition information associated with the database table.

3. The method of claim 2, wherein the act of obtaining schema definition information comprises obtaining schema definition information for the prior version.

4. The method of claim 3, wherein the act of obtaining schema definition information further comprises obtaining schema definition information for versions associated with the database table in addition to the prior version.

5. The method of claim 2, wherein the act of obtaining schema definition information comprises receiving said schema definition information from a user.

6. The method of claim 2, wherein the act of obtaining schema definition information comprises receiving said schema definition from a database change management application.

7. The method of claim 2, wherein the act of obtaining schema definition information comprises receiving said schema definition information directly from a database management system.

8. The method of claim 1, wherein the act of extracting data comprises unloading data stored in the database table to a result set data structure.

9. The method of claim 8, wherein the result set data structure comprises a computer file.

10. The method of claim 1, wherein the act of extracting data comprises generating a file that encodes therein a definition of the schema associated with the prior version.

11. The method of claim 1, wherein the act of extracting data comprises:
unloading a datum from the database table, said datum having a first format; and
transforming the unload datum to a second format.

12. The method of claim 1, wherein the act of extracting data comprises:
identifying a row in the database table;
determining a version associated with the identified row; and
extracting data from the identified row in accordance with the determined version.

13. The method of claim 12, wherein the acts of identifying, determining and extracting are repeated for each row in the database table.

14. A program storage device, readable by a programmable control device, comprising instructions stored on the program storage device for causing the programmable control device to:
receive a request to extract data from a database table, the database table having a current version associated with a current schema of the database table and a prior version associated with a prior schema of the database table, the request directed the prior version; and
extract data from the database table based on the table schema associated with the prior version.

15. The program storage device method of claim 14, wherein the instructions to receive a request further comprise instructions to obtain schema definition information associated with the database table.

16. The program storage device of claim 15, wherein the instructions to obtain schema definition information comprise instructions to obtain schema definition information for the prior version.

17. The program storage device of claim 16, wherein the instructions to obtain schema definition information further comprise instructions to obtain schema definition information for versions associated with the database table in addition to the prior version.

18. The program storage device of claim 15, wherein the instructions to obtain schema definition information comprise instructions to receive said schema definition information from a user.

19. The program storage device of claim 15, wherein the instructions to obtain schema definition information comprise instructions to receive said schema definition from a database change management application.

20. The program storage device of claim 15, wherein instructions to obtain schema definition information comprise instructions to receive said schema definition information directly from a database management system.

21. The program storage device of claim 14, wherein the instructions to extract data comprise instructions to unload data stored in the database table to a result set data structure.

22. The program storage device of claim 21, wherein the instructions to unload data to a result set data structure comprise instructions to unload data to a computer file.

23. The program storage device of claim 14, wherein the instructions to extract data comprise instructions to generate a file that encodes therein a definition of the schema associated with the prior version.

24. The program storage device of claim 14, wherein the instructions to extract data comprise instructions to:
unload a datum from the database table, said datum having a first format; and
transform the unload datum to a second format.

25. The program storage device of claim 14, wherein the instructions to extract data comprise instructions to:
identify a row in the database table;
determine a version associated with the identified row; and
extract data from the identified row in accordance with the determined version.

26. The program storage device of claim 25, wherein the instructions to identify, determine and extract are repeated for each row in the database table.

27. A relational database data-unload command, comprising:
a table-identifier to identify a table in a relation database from which to unload data;
a version-identifier to identify a version of the table identified by the table-identifier the data-unload command is to be executed against.

28. The relational database data-unload command of claim 27, further comprising one or more column-identifiers to specify the columns to unload from the table identified by the table-identifier.

29. The relational database data-unload command of claim 28, further comprising one or more transformation-identifiers to specify a function to apply to a datum unloaded from a specified column of the table identified by the table-identifier.

30. A computer system, comprising:
a central processing unit;
first storage operatively coupled to the central processing unit, the first storage having stored therein at least a portion of a relational database table; and
second storage operatively coupled to the central processing unit and the first storage, the second storage having stored therein at least a portion of a database management system, the database management system adapted to
receive a request to extract data from the relational database table, the relational database table having a current version associated with a current schema of the relational database table and a prior version associated with a prior schema of the relational database table, the request directed the prior version, and
extract data from the relational database table based on the table schema associated with the prior version.
